(19) United States
(12) Patent Application Publication
(10) Pub. No.: US 2023/0239609 A1
(43) Pub. Date: Jul. 27, 2023

(54) HEADPHONES

(71) Applicant: Burmester Audiosysteme GmbH, Berlin (DE)

(72) Inventors: Stefan Größler, Berlin (DE); Ajan Hannemann, Berlin (DE); Pascal Bings, Berlin (DE)

(73) Assignee: Burmester Audiosysteme GmbH, Berlin (DE)

(21) Appl. No.: 17/919,040

(22) PCT Filed: Apr. 13, 2021
(86) PCT No.: PCT/EP2021/059558

§ 371 Date: Oct. 14, 2022

(30) Foreign Application Priority Data
Apr. 16, 2020 (EP) 20169905.5
Apr. 16, 2020 (EP) 20169938.6

(51) Int. Cl. H04R 1/28; H04R 1/10

(52) U.S. Cl. CPC H04R 1/2826; H04R 1/105; H04R 1/1008; H04R 1/1075; H04R 2460/11

(57) ABSTRACT

Headphones, with one or two earcups (10), wherein each earcup (10) includes an electroacoustic sound generator (12) having a membrane (13) configured to radiate sound; a rear wall (14), wherein the membrane is arranged between the rear wall (14) and the user’s ear when the headphones are used, wherein a rear side of the membrane (13) faces a rear volume (26) between the membrane (13) and the rear wall (14) and a front side of the membrane (13) faces a front volume (20) between the membrane (13) and the user’s ear; and a tube (18) having a first and a second opening and an inner volume, wherein the tube (18) is arranged between the membrane (13) and the rear wall (14), and wherein the first opening of the tube (18) faces the membrane (13) and the second opening of the tube faces a peripheral environment behind the rear wall (14).

### TECHNICAL FIELD

Embodiments of the present disclosure relate to headphones. Headphones typically include at least one, preferably two earcups, each of which is equipped with an electroacoustic sound generator.

### BACKGROUND

In a typical design, headphone earcups comprise a housing which contains an electroacoustic sound generator. The sound generator contains a membrane, sometimes referred as diaphragm, which is deflected when electrical signals are applied to it, so that a sound is generated by the membrane. The earcup can have an ear pad ring which surrounds or lies over the ear of a user during normal use of the headphones.

Depending on the desired application of typical headphones, the housing is either designed to allow sound to pass through (open headphones) or to prevent most sound from passing through (closed headphones). However, both configurations – open headphones and closed headphones – provide advantages and disadvantages depending on the situation.

### SUMMARY

In light of the above, headphones are suggested. Further aspects, advantages, and features are apparent from the dependent claims, the description, and the accompanying drawings.

Headphones are suggested according to the present disclosure with one or two earcups, wherein each earcup comprises: an electroacoustic sound generator having a membrane configured to radiate sound; a rear wall, wherein the membrane is arranged between the rear wall and the user’s ear when the headphones are used, wherein a rear side of the membrane faces a rear volume between the membrane and the rear wall and a front side of the membrane faces a front volume between the membrane and the user’s ear; and a tube having a first and a second opening and an inner volume, wherein the tube is arranged between the membrane and the rear wall, and wherein the first opening of the tube faces the membrane and the second opening of the tube faces a peripheral environment behind the rear wall.

Accordingly, the design of the headphones of the present disclosure is improved compared to conventional headphones. The sound experience of a user can be improved. In particular, headphones as described herein having a tube may compensate the influence of potential acoustic leaks in the front volume and improve the bass response of the earcups.

According to a further aspect, earcups are suggested, comprising: an electroacoustic sound generator having a membrane configured to radiate sound; a rear wall, wherein the membrane is arranged between the rear wall and the user’s ear when the headphones are used, wherein a rear side of the membrane faces towards the rear wall and a front side of the membrane faces a front volume between the membrane and the user’s ear; wherein the headphones have a closed configuration and an open configuration. In particular, the tube can be configured to allow sound to pass through in the closed configuration and the tube can be configured to prevent most sound from passing through in the open configuration.

With open headphones, a desired sound reproduction over the frequency range of human hearing can normally be realized more easily than with closed headphones. One of the main reasons for this is that, besides the sound it emits towards the ear, a membrane also generates and radiates sound on its rear side, facing away from the ear. In open headphones, this sound is radiated into the environment and does not interfere with the generation of the sound that is directed towards the ear. In closed headphones, however, the sound that is radiated from the rear side of the membrane is reflected on the inside of the housing, giving rise to local pressure increases in the housing, which can even affect the oscillation of the membrane. On the other hand, closed headphones offer the advantage that the user is shielded to a certain degree from external noises, and the headphones radiate little sound to the user’s environment, with the result that people in the vicinity of the user are exposed to less disturbing noise from the headphones than with open headphones. Closed headphones may optionally also be furnished with apertures, which however are dimensioned such that they do not significantly detract from the shielding effect.

A tube according to the present disclosure may allow low frequencies to pass from the rear volume through the rear wall into the environment. This reduces unwanted reflections of bass frequencies at the rear wall back into the user’s ear and unwanted effects on the oscillation of the membrane. The tube can have a size configured in that the air at the inner volume of the tube together with the rear volume and the compliance of the membrane form an acoustic low pass filter.

Open headphones tend to have the whole back of the earcup open, wherein open means acoustically open. The back of the earcover, the rear wall, is often covered by an acoustically permeable mesh. Open headphones are very prone to acoustic leakage and have very little isolation. Closed headphones have the entire back closed. This offers the potential for isolation and lack of leakage. However, they are generally not as good as open headphones. There are also “semi-open” headphones. In semi open headphones, the earcup is at least partly closed and there are holes or slots in the back of the earcup. According to an aspect, the headphones are closed or semi closed headphones. In an alternative, the headphones have two configurations, one closed and one open configuration.

According to a further aspect, headphones are suggested with one or two earcups, wherein each earcup comprises: an electroacoustic sound generator having a membrane configured to radiate sound; a rear wall, wherein the membrane is arranged between the rear wall and the user’s ear when the headphones are used, wherein a rear side of the membrane faces a rear volume between the membrane and the rear wall and a front side of the membrane faces a front volume between the membrane and the user’s ear; wherein the headphones have a closed configuration and an open configuration. In particular, the rear wall can be configured to allow sound to pass through in the open configuration and the rear wall being configured to prevent most sound from passing through in the closed configuration

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a schematic cross section view of headphones according to embodiments described herein;

FIG. 2 shows a schematic cross section view of headphones according to embodiments described herein; and

FIG. 3 shows a rear wall according to an embodiment in an open configuration;

FIG. 4 shows the rear wall of FIG. 3 in a closed configuration; and

FIG. 5 shows a rear wall with a protection element.

### DETAILED DESCRIPTION OF EMBODIMENTS

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment can apply to a corresponding part or aspect in another embodiment as well.

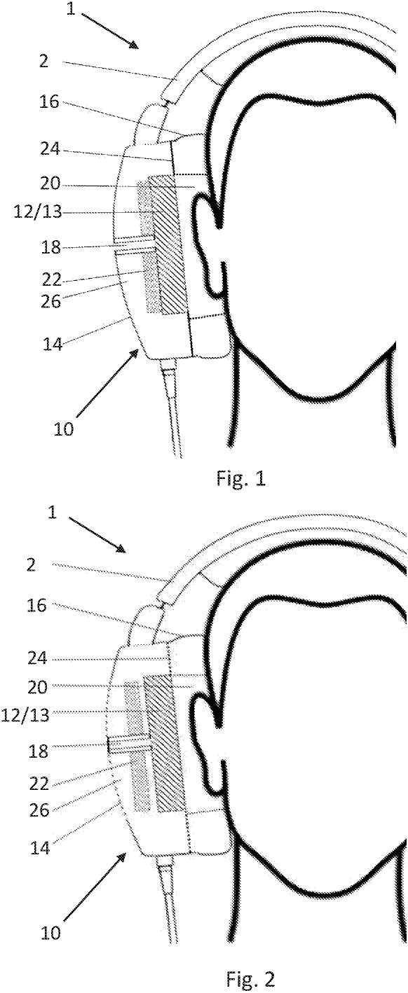

With exemplary reference to FIG. 1, headphones with one or two earcups 10 are shown on a user’s head. Each earcup 10 comprises: an electroacoustic sound generator 12 having a membrane 13 configured to radiate sound; a rear wall 14, wherein the membrane is arranged between the rear wall 14 and the user’s ear when the headphones are used, wherein a rear side of the membrane 13 faces a rear volume 26 between the membrane 13 and the rear wall 14 and a front side of the membrane 13 faces a front volume 20 between the membrane 13 and the user’s ear; and a tube 18 having a first and a second opening and an inner volume, wherein the tube 18 is arranged between the membrane 13 and the rear wall 14, and wherein the first opening of the tube 18 faces the membrane 13 and the second opening of the tube faces a peripheral environment behind the rear wall 14.

The headphones shown in FIG. 1 are closed headphones or can be described as headphones in a closed configuration. The headphones shown in FIG. 2 are open headphones or can be described as headphones in an open configuration.

In FIG. 1, sound propagates from the membrane 13 through the first opening of the tube 18, through the inner volume of the tube 18 through the second opening of the tube 18 into the peripheral environment behind the rear wall 14. Tube 18 can be described as an acoustic bypass from the membrane 13 into the environment parallel to the rear wall 14. The rear wall 14 can be part of the housing of the earcup 10. By bypassing the rear wall 14, unwanted reflections at the rear wall 14, especially reflections of frequencies below 500 Hz, are significantly reduced.

Headphones 1 can have exactly two earcups 10 and a band 2 as shown in FIGS. 1 and 2, wherein the band 2 is connected to the two earcups 10 and carries the earcups 10 when the headphones are used. The two earcups 10 can each have a sound generators 12, membranes 13, rear walls 14, and/or tubes 18 which are essentially mirror images of each other.

Tube 18 has a first and a second opening and an inner volume. In some embodiments, the inner volume of the tube is empty, which means that it is filled with air. In some other embodiments, the inner volume of the tube 18 may be filled with a material, which does not influence sound propagation, for example, a foam material or an acoustic permeable mesh.

The tube 18 may have a dimension which creates an acoustic low-pass filter and thereby increasing the sound quality for a user. The tube has preferable a length which is larger than its diameter. However, the length is not too large so that the compliance of the air inside the tube is neglectable compared to the compliance of the air surrounding the tube in the inner volume and the compliance of the membrane. Specifically, the compliance of the air of the inner volume of the tube 18 together with the compliance of the membrane and the compliance of the air in the rear volume 26 defines an acoustic low-pass filter between the rear volume 26 and the peripheral environment behind the rear wall 14 or behind the second opening of the tube 18. Only low frequencies can pass through the tube into the environment. The acoustic compliance is the compressibility of a small volume and the reciprocal of acoustic stiffness.

In some embodiments, the cut-off frequency of the acoustic low-pass filter is between 50 Hz and 500 Hz, specifically between 80 Hz and 300 Hz.

The tube 18 can be cylindrical in some embodiments. However, other shapes are possible, for example, a hexagonal shape (honeycomb shape). The tube 18 can have a length from the first to the second opening between 0.8 cm and 3 cm. In some embodiments, tube 18 has a diameter between 1.2 mm to 6 mm. In some embodiments, tube 18 is arranged in the center of the membrane 13 which may correspond to the center of a plane between the rear volume 26 and the front volume 20.

The tube 18 may be a single tube or may also comprise a plurality of parallel tubes. Each of the plurality of parallel tubes can have a length from their first to their second opening between 0.8 cm and 3 cm. The sum of all parallel tubes together can have a diameter between 1.2 mm to 6 mm. A plurality of parallel tubes can be closely packed, for example, in an elongated a honeycomb structure.

According to an embodiment, the tube 18 has a length from the first to the second opening, wherein the inner diameter of the tube 18 is essentially constant over its length. In another embodiment, each of the plurality of parallel tubes have a length from their first to their second opening, wherein the inner diameter of the plurality of tubes 18 is essentially constant over their length. A constant diameter improves sound propagation of certain frequencies from the membrane into the environment.

The second opening of the tube 18 facing the peripheral environment behind the rear wall 14 can be arranged in a plane with the rear wall 14 so that it corresponds with a hole in the rear wall 14. In some alternative embodiments, second opening of the tube 18 leads into a cone which increases in size towards the rear wall 14 so that a hole in the rear wall 14 is larger than the second opening of the tube 18.

According to an embodiment, each earcup 10 can additionally comprise an acoustic attenuation 22, wherein the acoustic attenuation 22 is arranged between the membrane 13 and the rear wall 14, wherein the acoustic attenuation 22 is configured to contact the membrane 13, specifically contact the membrane 13 in the closed configuration. Acoustic attenuation 22 may not contact the membrane 13 in the open configuration. The acoustic attenuation 22 mechanically contacts the rear side of the membrane 13 in the closed configuration as shown in FIG. 1. It is actively attenuating the vibration of the rear side of the membrane 13 in the closed configuration. This reduces sound radiation to the user’s environment. Furthermore, this reduces sound radiation towards the rear wall 14 and thereby reduces reflected sound from the rear wall back to the user’s ear. This enhances sound quality in the closed configuration. In the open configuration, acoustic attenuation 22 is not contacting the membrane and does, therefore, not have significant impact on the sound experience of the user.

In some embodiments, acoustic attenuation 22 is arranged around tube 18. In other words, acoustic attenuation 22 and tube 18 are arranged acoustically parallel to each other. Tube 18 bypasses the acoustic attenuation 22. The acoustic attenuation 22 may lower the bass and lower middle frequencies of the membrane. A parallel arranged tube 18 can work against this effect and increases the sound quality for a user.

In some embodiments illustrated in FIGS. 1 and 2, headphones 1 have a closed configuration and an open configuration. The rear wall can be configured to allow sound to pass through in the open configuration and to prevent most sound from passing through in the closed configuration. Open and closed configurations relate to acoustic properties. In other words, rear wall 14 may have an acoustically open configuration and an acoustically closed configuration. The rear wall 14 may be configured to prevent most sound from passing through in the closed configuration, for example, by forming a closed surface with solid elements. The rear wall can be configured to allow sound to pass through in the open configuration by, for example, having gabs or having a non-closed surface.

The rear wall 14 may be configured to prevent most sound from passing through in the closed configuration. However, sound propagation is frequency dependent. I should be understood that preventing most sound from passing through has to be interpreted in the sense of typical relevant frequencies for headphones.

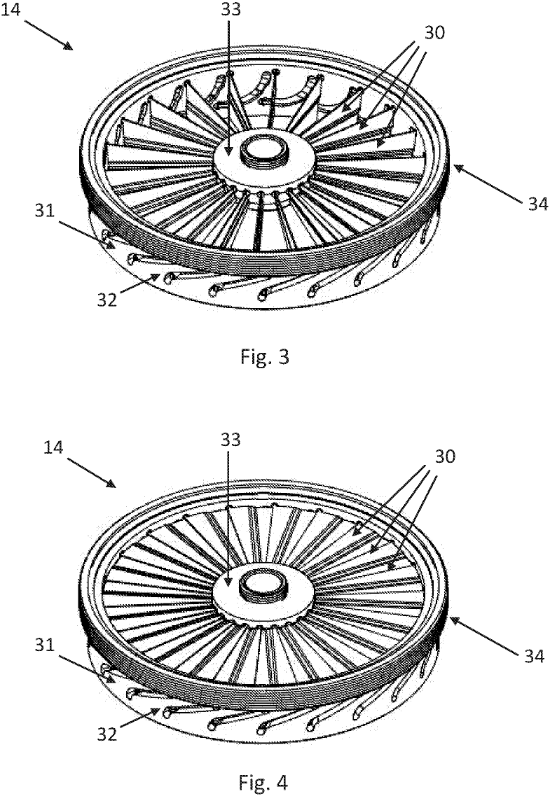

A user may manually switch between the closed configuration and the open configuration of the head phones 1 and/or the rear wall 14. An example of the switching mechanism or shifter 35 is further described later in FIGS. 3 and 4. According to an embodiment, each earcup 10 additionally comprises a shifter 35 configured to be operated by a user to transfer the headphones from the open configuration to the closed configuration and vice versa.

The each earcup 10 can comprise an ear pad ring 16, wherein the earpad ring 16 surrounds or lies over an ear of a user when the headphones are used. Ear pad rings may be shaped oval or round to fit the form of a user’s ear. In some cases earpad ring 16 surrounds a user’s ear and the headphones are categorized as “over - ear” headphones. In other cases earpad ring 16 lie over the ear of a user and the headphones are categorized as “on - ear” headphones.

According to an embodiment, each earcup 10 can additionally comprise a tube 18 having a first and a second opening and an inner volume, wherein the tube 18 is arranged between the membrane 13 and the rear wall 14, and wherein the first opening of the tube 18 faces the membrane 13 and the second opening of the tube faces a peripheral environment behind the rear wall 14. In one embodiment, tube 18 is configured to allow sound to pass through in the closed configuration and tube 18 is configured to prevent most sound from passing through in the open configuration. Both ends of the tube 18 can be open in the closed configuration of the headphones. This may compensate the influence of potential acoustic leaks in the front volume 20 and improve the bass response of the earcups by a reduction of reflected frequencies in the bass region.

The front volume 20 can be defined by a baffle 24, the membrane 13 and the earpad ring 16 together with the head of a user, wherein the soft material of the earpad ring 16 is part of the front volume 20.

In some embodiments, tube 18 has a closure and the second opening of the tube 18 is closed by the closure in the open configuration of the headphones as shown in FIG. 2 and not closed in the closed configuration of the headphones as shown in FIG. 1. The shifter can be coupled to the closure, so that transferring the headphones from the open configuration to the closed configuration opens the closure and transferring the headphones from the closed configuration to the open configuration closes the closure.

In some embodiments, electroacoustic sound generator 12 is a planar magnetic sound generator. The electroacoustic sound generator 12 can also be an electrostatic sound generator. These types have some advantages over dynamic magnetic sound generators. In a planar magnetic sound generator or electrostatic sound generator, the entire membrane moves to create a planar sound wavefront instead of the focused spherical wavefront that’s common for dynamic sound generation. Planar magnetic sound generators and electrostatic sound generators typically have a better bass response with more extension to the low-end frequencies, especially between 20 Hz to 300 Hz. Planar magnetic and electrostatic sound generators also benefit from the thinner membrane, which gives them a tighter bass response that reacts faster to the changes in the input signal. This gives them a punchy bass that’s not overpowering, and that doesn’t over-extend into the mid-range. A planar sound wavefront is advantages for a the tube 18 to channel low bass frequencies into the environment and thereby reduce unwanted reflected sound.

In an embodiment, the surface of the membrane 13 can be at least 5 or even 10 times larger than the first opening of the tube 18. The tube 18 can be arranged in the center of the membrane 13. If the earcup has a plurality of parallel tubes, the surface of the membrane 13 can be at least 5 or even 10 times larger than the sum of the surface of first openings of the plurality of tubes 18.

According to an aspect, each earcup 10 additionally comprises a baffle 24 as shown in FIGS. 1 and 2. The baffle 24, the membrane 13 and the earpad ring 16 together with the head of a user define a front volume 20 and the baffle 24 and the membrane 13 together with the rear wall 14 define a rear volume 26. As shown in in FIGS. 1 and 2 the material of earpad ring 16 is part of the front volume 20. In other words, baffle 24 together with the membrane 13 separate the front volume 20 and the rear volume 26.

The baffle 24 can have a first acoustic resistance in the closed configuration and a second acoustic resistance in the open configuration, wherein the first resistance is larger than the second resistance. For example, the baffle 24 can include two layers, each comprising a plurality of gabs or holes. In the closed configuration, the gabs or holes of the layers do not overlap creating a closed surface with a first acoustic resistance, in another configuration the gabs or holes of both layers overlap creating a non-closed surface with a second acoustic resistance. The layers may be moveable (rotation or linear shifting) with respect to each other to switch between the configurations.

FIGS. 3 and 4 show an embodiment of the rear wall 14 in an open configuration in FIG. 3 and in a closed configuration in FIG. 4. The rear wall comprises a plurality of solid elements 30. The solid elements are contacting each other in the closed configuration and are not contacting each other in the open configuration. In some embodiments, solid elements 30 form a closed surface in the closed configuration and do not form a closed surface in the open configuration. The solid elements 30 can be sheets. In some embodiments, solid elements 30 are rotatable, specifically rotatable around an axis parallel to the rear wall. Solid elements 30 are configured to block sound. Solid elements can comprise a metal or a hard plastic.

Tube 18 is not shown in FIGS. 3 and 4. However, tube 18 can be placed in the center of the inner ring structure 33.

As shown in the embodiment of FIG. 3, sheets are not contacting each other in the open configuration and rotate between the closed and the open configuration. However, in some alternative embodiments, sheets 30 can be arranged in two or more layers, wherein each layer has sheets and gaps. In the open configurations, sheets of each layer overlap and gaps of each layer overlap. In the closed configurations, gaps and sheets of different layers overlap, so that each gap is closed by a sheet of another other layer. The layer or the layers may rotate around an axis perpendicular to the rear wall, in other words, the layer or layers rotate within the plane of the rear wall.

In the embodiments of FIGS. 3 and 4, the rear wall comprises a first outer ring structure 31/34 and an inner ring structure 33. The sheets 30 are connected to the outer ring structure 31 and the inner ring structure 33. The rear wall can be switched between the open configuration and the closed configuration by rotating a portion of the outer ring structure 31/34 relative to the inner ring structure 33. Specifically, rear wall 14 comprises a first outer ring structure 31 and a second outer ring structure 34. Sheets 30 have triangle shapes, wherein a first end is rotatable connected to the inner ring structure 31, a second end is rotatable connected to the outer ring structure 31/34 and a third end is placed in a recess or elongated hole 32 of the outer ring structure 31/34. The recess or elongated hole 32 defines a path for the third end. Upon following the path of the recess or elongated hole 32, the third ends cause the sheets 30 to rotate. The recess or elongated hole 32 may be formed to cause a rotation from a starting point defined as 0° to an end point at between 60° and 90°.

Sheets 30, specifically the third ends of sheets 30, may be coupled to second outer ring structure 34, so that rotation of the second outer ring structure 34 relative to the first outer ring structure 31 causes the sheets to rotate.

The second outer ring structure 34 may act as a shifter for manually shifting the headphones from the open configuration to the closed configuration and vice versa operated by a user.

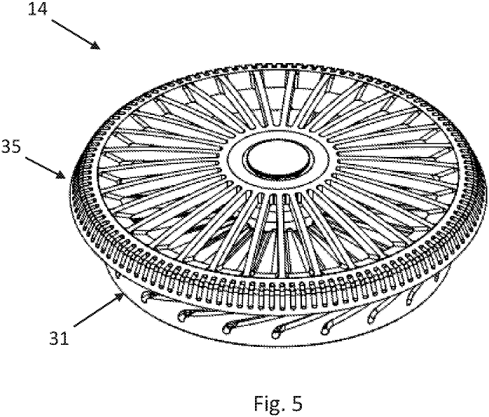

In a further development of rear wall 14 may comprise a protection element as shown in FIG. 5. The structure shown in FIGS. 3 and 4. may be vulnerable for mechanical impacts. A mechanical protection element shields the structure from mechanical contact. The protection element 35 may be connected to the outer ring structure 34. In some embodiments, protection element 35 may act as a shifter configured to be operated by a user to transfer the headphones from the open configuration to the closed configuration and vice versa.

According to some aspects of the present disclose, earcup 10 can comprise dust protection elements which shield the mechanical and/or electronic parts of the headphones from dust and debris. Specifically, a dust protection element can be placed between protection element 35 and sheets 30 and/or between electroacoustic sound generator 12 and a user’s ear. Dust protection elements do not influence sound propagation and comprise, for example, a foam structure or an acoustic permeable mesh.

Some examples are disclosed in the following clauses: 1. Headphones (1), with one or two earcups (10), wherein each earcup (10) comprises:
an electroacoustic sound generator (12) having a membrane (13) configured to radiate sound; and
a rear wall (14), wherein the membrane is arranged between the rear wall (14) and an ear of a user when the headphones are used, wherein a rear side of the membrane (13) faces a rear volume (26) between the membrane (13) and the rear wall (14) and a front side of the membrane (13) faces a front volume (20) between the membrane (13) and the ear of the user;
wherein the headphones have a closed configuration and an open configuration, the rear wall being configured to allow sound to pass through in the open configuration and the rear wall being configured to prevent most sound from passing through in the closed configuration.

2. Headphones according to clause 1, wherein each earcup (10) additionally comprises a tube (18) having a first and a second opening and an inner volume, wherein the tube (18) is arranged between the membrane (13) and the rear wall (14), and wherein the first opening of the tube (18) faces the membrane (13) and the second opening of the tube faces a peripheral environment behind the rear wall (14).

3. Headphones according to clause 2, wherein the tube (18) is configured to allow sound to pass through in the closed configuration and the tube (18) is configured to prevent most sound from passing through in the open configuration.

4. Headphones according to any of the clauses 2 or 3, and wherein the compliance of the air of the inner volume of the tube (18) together with the compliance of the membrane 13 and the compliance of the air in the rear volume defines an acoustic low-pass filter between the rear volume (26) and the peripheral environment behind the rear wall (14).

5. Headphones according to clause 4, wherein the cut-off frequency of the acoustic low-pass filter is between 50 Hz and 500 Hz, specifically between 80 Hz and 300 Hz.

6. Headphones according to any of the clauses 2 to 5, wherein the tube (18) is cylindrical.

7. Headphones according to any of the clauses 2 to 6, wherein the tube (18) is arranged in the center of the membrane (13).

8. Headphones according to any of the clauses 2 to 7, wherein the second opening of the tube (18) is closed by a closure in the open configuration of the headphones and open in the closed configuration of the headphones.

9. Headphones according to any of the preceding clauses, wherein each earcup (10) additionally comprises an acoustic attenuation (22), wherein the acoustic attenuation (22) is arranged between the membrane (13) and the rear wall (14), wherein the acoustic attenuation (22) is configured to contact the membrane (13) in the closed configuration and not to contact the membrane (13) in the open configuration.

10. Headphones according to any of the preceding clauses, wherein each earcup (10) additionally comprises a shifter (35) configured to be operated by a user to transfer the headphones from the open configuration to the closed configuration and vice versa.

11. Headphones according to any of the preceding clauses, wherein each earcup (10) additionally comprises an ear pad ring (16), wherein the earpad ring (16) surrounds or lies over an ear of a user when the headphones are used, and a baffle (24), wherein the baffle (24), the membrane (13) and the earpad ring (16) together with the head of a user define the front volume (20) and the baffle (24) and the membrane (13) together with the rear wall (14) define a rear volume (26), the baffle (24) having a first acoustic resistance in the closed configuration and a second acoustic resistance in the open configuration, wherein the first resistance is larger than the second resistance.

12. Headphone according to any of the preceding clauses, wherein the rear wall (14) comprises a plurality sheets (30).

13. Headphone according to clause 12, wherein the plurality of sheets (30) are rotatable.

14. Headphone according to any of the clauses 12 or 13, wherein the plurality of sheets are contacting each other in the closed configuration and wherein the sheets are not contacting each other in the open configuration.

15. Headphone according to any of the clauses 12 to 14, wherein the plurality of sheets form a closed surface in the closed configuration and do not form a closed surface in the open configuration.

REFERENCE NUMBERS

| | |
|---|---|
| 1 | headphones |
| 2 | band |
| 10 | earcups |
| 12 | electroacoustic sound generator |
| 13 | membrane |
| 14 | rear wall |
| 16 | ear pad ring |
| 18 | tube |
| 20 | front volume |
| 22 | acoustic attenuation |
| 24 | baffle |
| 26 | rear volume |
| 30 | solid elements / sheets |
| 31 | first outer ring structure |
| 32 | recess / elongated hole |
| 33 | inner ring structure |
| 34 | second outer ring structure / shifter |
| 35 | protection element / shifter |

1. Headphones, with one or two earcups (10), wherein each earcup (10) comprises:
an electroacoustic sound generator (12) having a membrane (13) configured to radiate sound;
a rear wall (14), wherein the membrane is arranged between the rear wall (14) and an ear of a user of said headphones, wherein a rear side of the membrane (13) faces a rear volume (26) between the membrane (13) and the rear wall (14) and a front side of the membrane (13) faces a front volume (20) between the membrane (13) and the user’s ear; and
a tube (18) having a first and a second opening and an inner volume, wherein the tube (18) is arranged between the membrane (13) and the rear wall (14), and wherein the first opening of the tube (18) faces the membrane (13) and the second opening of the tube faces a peripheral environment behind the rear wall (14),
wherein the headphones have a closed configuration and an open configuration, wherein the rear wall (14) is configured to allow sound to pass through in the open configuration and to prevent most of the sound from passing through in the closed configuration.

2. Headphones according to claim 1, wherein a compliance of the air of the inner volume of the tube (18) together with the compliance of the membrane (13) and the compliance of the air in the rear volume defines an acoustic low-pass filter between the rear volume (26) and the peripheral environment behind the second opening of the tube.

3. Headphones according to claim 2, wherein a cut-off frequency of the acoustic low-pass filter is between 50 Hz and 500 Hz.

4. Headphones according to claim 1, wherein the tube (18) is cylindrical.

5. Headphones according to claim 1, wherein the tube (18) has a length from the first to the second opening and wherein an inner diameter of the tube (18) is essentially constant over its length.

6. Headphones according to claim 1, wherein the tube (18) has a length from the first to the second opening between 0.8 cm and 3 cm.

7. Headphones according to claim 1, wherein the tube (18) has an inner diameter between 1.2 mm and 6 mm.

8. Headphones according to claim 1, wherein the tube (18) is a single tube or wherein the tube (18) is formed by a plurality of parallel tubes.

9. Headphones according to claim 1, wherein the tube (18) is arranged in a center of the membrane (13).

10. Headphones according to claim 1, wherein the electroacoustic sound generator (12) is a planar magnetic sound generator or an electrostatic sound generator.

11. Headphones according to claim 1, further comprising an acoustic attenuation (22), wherein the acoustic attenuation (22) is arranged between the membrane (13) and the rear wall (14), wherein the acoustic attenuation (22) is in contact with the membrane (13) and wherein the tube (18) bypasses the acoustic attenuation (22).

12. Headphones according to claim 1, wherein the headphones comprise two earcups (10) and a band (2), wherein the band (2) is connected to the two earcups (10) and carries the earcups (10) when the headphones are used.

13. Headphones according to claim 1, wherein each earcup (10) comprise an earpad ring (16), wherein the earpad ring (16) surrounds or lies over an ear of a user when the headphones are used, and a baffle (24), wherein the baffle (24), the membrane (13) and the earpad ring (16) together with the head of a user define the front volume (20) and the baffle (24) and the membrane (13) together with the rear wall (14) define the back volume (26), wherein the baffle is configured to reduce sound transmission between the front volume (20) and the back volume (26).

14. Headphones according to claim 1, wherein the tube (18) is configured to allow sound to pass through in the closed configuration and configured to prevent most sound from passing through in the open configuration.

15. Headphones according to claim 14, wherein the headphones comprise a closure configured to close the second opening of the tube (18) in the open configuration to prevent most sound from passing through.

16. Headphones according to claim 1, wherein the rear wall (14) comprises a plurality sheets (30).

17. Headphones according to claim 16, wherein the plurality of sheets (30) are rotatable.

18. Headphones according to claim 16, wherein the plurality of sheets are contacting each other in the closed configuration and wherein the sheets are not contacting each other in the open configuration.

19. Headphones according to claim 16, wherein the plurality of sheets form a closed surface in the closed configuration and do not form a closed surface in the open configuration.

20. Headphones according to claim 3, wherein the cut-off frequency of the acoustic low-pass filter is between 80 Hz and 300 Hz.
